(19) United States
(12) Patent Application Publication
(10) Pub. No.: US 2004/0219287 A1
(43) Pub. Date: Nov. 4, 2004

(54) Labelled articles and uses thereof

(76) Inventors: Christopher Regan, Wigton (GB); Richard Waning, Wigton (GB)

Correspondence Address: WENDEROTH, LIND & PONACK, L.L.P., 2033 K STREET N. W., SUITE 800, WASHINGTON, DC, 20006-1021, US

(21) Appl. No.: 10/488,705

(22) PCT Filed: Sep. 26, 2002
(86) PCT No.: PCT/EP02/10816

(30) Foreign Application Priority Data
Sep. 27, 2001 (GB) 0123278.4

(51) Int. Cl. B44F 1/12

(52) U.S. Cl. 427/7; 435/262

(57) ABSTRACT

There is described a process for labeling an article and/or document for authentication purposes. The article or document (such as BOPP and/or cellulose film) incorporates therein particles having a taggant bound to the surface thereof. The preferred taggant is a DNA strand of at least eight (preferably 25) base pairs long attached to inorganic particles by the addition reaction between an acrylate group and a polar group such as amino or hydroxy. Alternatively silica particles can be modified by reacting first with aminopropyltriethoxy silane and then a reagent selected from: a diacid with a polyethylene glycol spacer group (e.g. polyethylene glycol dicarboxymethyl) succinic anhydride; and/or a diisothiocyanate (e.g. 1,4-phenylene diisothiocyanate (PDITC)) to form functional silica particles capable of reacting directly with a terminal amide and/or hydroxy group of an oligonucleotide such as DNA. The tagged particles can be detected by use of a fluorescent probe which hybridises with the DNA sequence selected tag the article or document.

The present invention relates to means for marking and/or labelling articles and/or documents to provide a unique non destructive method of authenticating the same. In another aspect the present invention relates to methods for making and verifying the authenticity of articles and/or documents. Further aspects of the invention related to authentic articles and/or documents protected by the verifying means of this invention and also associated tags, labels and/or security documents.

It is desirable to authenticate articles and/or documents to identify them to verify they are non-counterfeit and/or to deter the copying and/or counterfeiting of such articles and/or documents. For example products of substantial value such as software, CDs, video-tapes, clothes, bottles of perfume, wines and alcoholic beverages, automotive parts, aeronautic industry parts, printed substrates such as tickets, bank notes, certificates, shares and the like and other important documents are all vulnerable to counterfeiting.

It is known in the field of security marking to use a taggant additive such as a UV, IRA, fluorescent additive in the coating of a substrate. For example this is described in WO 00/26021 (Avery). However there are several problems with these methods. The additive must be applied in a coating onto the substrate if it is to be readily detected. This requires an extra coating step. If the taggant additive is detected it may be readily copied by a counterfeiter. There are only a limited number of taggants available

It is possible to use informational molecules such as proteins, amino acids, peptides, DNA, RNA (containing sequences of base pairs) as taggants. Such informational molecules provide a very large number of different permutations of their consistent elements so there are many unique tags which can be selected and used to identify each article.

DNA contains two complementary strands, and each strand consists of a sequence of bases. The process to bind two complementary strands of DNA back together is called hybridization. The two strands are similar to a lock and key—one will only fit the other. If a strand consists of a sequence of 25 bases, it means that there are over one thousand million million possible combinations. If the two stranded DNA molecule is separated, it is possible to create a very effective security marking system; The principle is that one strand of the DNA is used to create a “biotag” (the ‘lock’), whereas the other half is bound to a fluorescent marker to create the fluorescent probe (the ‘key’). The probe for the elected DNA is kept by the person wishing to verify the article.

As one particular sequence of DNA will only bind to its complementary ‘key’, any potential counterfeiter must know the sequence of the DNA biotag in order for it to be copied. As there are more than one thousand million million potential combinations for DNA sequence containing 25 bases, the possibility that a counterfeiter chooses the correct sequence by chance is almost impossible. As there are lots of possible sequences it is possible to have a different Biotag for each customer, end use, product etc. For example if it is required detailed tracking information can be obtained about each type of product, source factory, production batch and/or individual article etc as each can be labelled with a unique DNA sequence.

However to protect the DNA it has previously been necessary to hide the DNA within the material from which the article is made as if raw DNA is incorporated into an article it will often not survive the manufacturing process. It is also difficult to incorporate sufficient amounts of DNA within the article especially at the surface thereof in concentrations which can readily be detected.

Therefore to analyse the DNA sequence of a DNA marked article it has been necessary to take a sample of the DNA tagged article, and isolate the DNA therefrom for example amplifying the DNA concentration with a classical technique based on the polymerase chain reaction (PCR) so the DNA sequence can be detected. Thus prior art methods which use DNA labeling are destructive of the tagged article (or at least a sample thereof) and cannot readily be used to authenticate articles in situ or which cannot be sampled.

The applicant has discovered a means of fixing a taggant (such as DNA) to an article so that the article can be authenticated in a non destructive manner.

Therefore broadly in accordance with the present invention there are provided particles, articles, processes, methods and/or uses as described herein and/or in the independent claims herein. Further preferred features of the invention are described herein and/or in the dependent claims herein, as well as in the description herein.

One aspect of the present invention provides tagged particles comprising a taggant strongly bound to the surface thereof.

Another aspect of the present invention provides a process for making tagged particles comprising reacting reactive particles with a taggant comprising a complementary reactive moiety thereon.

In a further aspect of the present invention there is provided an article comprising one or more tagged particles of the invention as described herein in detectable amounts.

In a yet further aspect of the present invention there is provided a method for authenticating an article comprising the step of exposing an article of the present invention to a non destructive detector to identify the taggant present therein.

In a further aspect of the present invention provides a method of manufacturing an product comprising the step of: incorporating one or more the tagged particles of the present invention into a product as an integral part of the product, by attaching or associating the particles to the product and/or by associating the particles with the product. Preferred products are those films described herein.

In another aspect of the invention there is provided a process for tagging a particle the process comprising the steps of:

(a) applying one or more chemical taggants optionally dispersed in a carrier medium to a particles having at least one reactive site thereon;

(b) reacting the or each chemical taggants with one or more reactive site(s) on the substrate(s) to strongly link the or each chemical taggants thereto,

to form one or more tagged particle(s), characterised in that

the linking reaction in step (b) exhibits at least one of the following properties:

(i) occurs in a sufficiently fast manner under the process conditions so that the reaction is substantially complete;

(ii) achieves the strong link to the particle in single step; and/or

forms a link which is substantially irreversible under the conditions of use of the particle and/or an article comprising said particles.

Taggants

Preferably the taggant is a chemical taggant and/or comprises a chromphore which absorbs and/or fluorescences in the non-visible region of the electromagnetic spectrum, more preferably in the UV, or infra red regions. More preferably the taggant is a chemical taggant, most preferably comprises an informational molecules such as strand of DNA and/or protein.

A preferred means of bonding a taggant such as DNA to a substrate uses complementary reactive sites (such as acrylate groups) on the taggant and a substrate (particle). This is more fully described in the applicant's co-pending European Patent Application 01108134.6 (21.88 EP) the contents of which are incorporated by reference.

A chemical taggant as used herein denotes a chemical species (such as a molecule) which can be readily distinguished from similar taggants to identify the tagged particle. Such a taggant could be for example a strand of DNA, DNA probe or part thereof, preferably comprising a sequence of at least 8 DNA base pairs (to provide better protection against deliberate or co-incidental copying of the sequence). Other taggants may include olgiotides, proteins or peptide chains (which comprise amino acid sequences) or any other molecule which can be build up from identifiable sub units to provide many permutations in the final taggant.

To detect DNA the hybridisation process may be used in which a single-stranded DNA fragment binds preferentially to its complementary sequence (or probe) when the two are in the presence of one another. The single stranded DNA sequence could also be an oligonucleotides, cDNA or DNA fragment. To provide sufficient variations for security marking it has been found that it is preferred that the DNA sequence on the article is at least 8 base pairs long.

An advantage of the present invention is that the tagged particles can comprise chemical taggants larger than necessary (e.g. DNA strands of many base pairs). Even if the taggant at the particle surface degrades somewhat (e.g. if the particles are added to a polymer before extrusion) sufficient base pairs at the surface thereof will survive to provide a unique sequence which is difficult to copy.

The present invention provides a means for disposing DNA at the surface of any article which is bound thereto and is resistant to removal.

If an article comprising DNA at its surface is exposed to its probe, the probe will bind to the article. If the probe is labelled in a suitable manner (e.g. with a radio isotope, UV, IR or fluorescent marker group) this label will only be detected on an authentic article containing the correct DNA sequence for the probe used. Thus if the surface of an article is exposed to the probe it can be readily authenticated.

Preferably the probe is complementary to the sequence fragment (more preferably of at least eight base pairs, most preferably at least twenty) starting at the DNA end bound to the particle. Thus if the free end of the DNA degrades during manufacture of the article the probe will still be able to uniquely identify the tagged particles.

Particles

The tagged particles of the invention are preferably substantially inert to and compatible with the materials which comprise the article to which they are added.

Preferably the particles comprise inorganic mineral and/or resin, more preferably they comprise inorganic silicates, silica and/or glass.

A “reactive particle ” as used herein denotes a particle having an effective concentration of free reactive sites deposed on the surface thereof, sufficient to react with the chemical taggant to form a tagged particle.

Reactive particles obtained and/or obtainable as described above are another aspect of the invention.

Reactive particle can be inherently reactive and/or may be pre-treated with a suitable reagent to functionalise the particle to provide sufficient reactive sites thereon.

As used herein “tagged particles” refer to particles comprising a chemical taggant bound on the surface thereof in sufficient concentration to be detectable by use of a suitable complementary probe.

Particles and/or the chemical taggant can be inherently functionalised or pre-treated.

Articles of the invention comprise a particulate taggant of the invention dispersed therein such that on expose to a taggant probe the chemical taggant can be detected.

Preferably particles are at the article surface. However the particles may also be within the bulk where probe can absorb/diffuse within the article.

Preferably the particles to be tagged have a mean size of less than about 100 microns, more preferably from about 0.1 to about 10 microns, most preferably from about 0.1 to about 1 microns. However the suitable particle size is governed by many factors known to a skilled person depending on the use. For example small particles may be desired to be incorporated in a thin substrate such a paper or films (e.g. for security documents) and/or if transparency is desired. The present invention is therefore not limited by particle size which is matched to the particular use desired for the tagged particles.

The particles to be tagged can be selected from many materials so to be compatible with a wide range of articles such as any of those given herein. The particles can also be added to blank substrates during production of for example a paper or film web (e.g. BOPP or cellulose film) to create a tagged substrate especially suitable for subsequent conversion (e.g. by coating, printing, lamination etc) into a security document. The tagged substrate can have the particles evenly dispersed therein or in a particular pattern.

The invention also comprises those particles suitable for being treated in the process of the invention, such particles comprising those having intrinsically reactive sites thereon and/or those comprising a material thereon which comprises the reactive sites.

It will also be appreciated that as used herein particle denotes any suitable support for the taggant and may comprise any suitable material capable of supporting the species bound thereto as described herein and may be of any suitable shape such as flat, roughed and/or curved.

Particles of the invention can also comprise two dimensional substrates such a flat surface. However in general suitable particles comprising reactive 2-D exterior surfaces and/or parts thereof. Such particles may be of at any scale and the reactive portion may comprise the closed surface of spheriodial articles such one or more particles (e.g. beads and/or granules) substantially spherical and/or irregular in shape.

The particle surface to be tagged may also be three dimensional where the surface should be considered any exposed surface whether at the exterior and/or within the interior voids of a particle and/or part thereof, for example particles of porous material and/or with porous coatings thereon (such as sintered glass) and/or a series of porous particles (such as porous glass beads). The porosity should be such that the article can be readily impregnated with a suitable carrier composition as described herein to functionalise the exposed surfaces thereof (including those in the voids and/or interstices). Other 3-D substrates that may be used comprise materials (either as the substrate per se and/or as a coating thereon) in a physical form which is highly open and/or of a high surface area such as dispersions having a gas as the dispersed phase e.g. hydrogels and/or aerogels. For 3-D substrates it is preferred that instead of units of exterior area the taggant density should be measured per unit volume or per unit surface area (as measured by any suitable technique such as desorption).

Modification of Particles

Preferably the particles are modified so that the taggant can be immobilised thereon. For example an inorganic particle (such as silica) can be modified with reactive sites thereon (such as a functional group selected from an activated unsaturated moieties (e.g. acrylate) and/or PEG linked silica, succinamidopropyl silica and/or isothiocyanate terminated silica) which are receptive to the selected taggant (such as DNA).

In one option preferred reactive site(s) on the taggant and/or particle:

(a) comprise one or more activated unsaturated moiet(ies) and/or complement(s) thereof; and/or

(b) are capable of undergoing a linking reaction with another species by at least one of the following means:

(i) in a sufficiently fast manner so that the reaction is substantially complete under the process conditions used;

(ii) form a strong link between the species and the substrate in single step; and/or

(iii) form a link between the species and the substrate which is substantially irreversible under the conditions of use of the substrate.

As used herein “reactive site” in its broadest sense (and unless the context herein clearly indicates otherwise) denotes any site capable of undergoing a linking reaction with a chemical taggant, it being preferred that the reaction having at least one of the aforementioned properties in (b).

Preferred reactive sites denotes site comprising one or more activated unsaturated moiet(ies) and/or complement(s) thereof as defined herein.

As used herein the first species preferably denotes a taggant species (and/or component(s) thereof) such as an (optionally organic) molecule. The final taggant used in a multi-reactive system may comprise one or more various other species attached in successive fashion (e.g. in a chain) to the first species bound to the reactive site on the particle to be tagged. In this manner taggants with any desired property can be used to tag a particle even if they are not suitable (and/or cannot be modified to be so) for directly linking to the reactive sites on the particle.

Optionally the taggant is disposed in a carrier medium such as an fluid, preferably liquid in which the first species (such as a molecule taggant or part thereof) may be dispersed and which for example is substantially inert to said species. Optionally the linking reaction occurs in a sufficiently fast manner that the reaction is substantially complete before the carrier fluid has evaporated therefrom (for example where the carrier fluid is applied as droplets).

The terms “strongly linked” and/or “strongly attached” as used herein mean substantially resistant to removal under the conditions (and with the other reagents) under which the taggants and/or particles will be used, for example when added to the article to be tagged. Preferably this means that the organic species (e.g. molecule) is linked to the reactive site by a covalent bond; more preferably via an average of at least one covalent bond per reactive site to organic species link. More preferably the bond so formed is substantially irreversible under the conditions of use of the tagged particle and/or is formed by a reaction which is substantially irreversible. Preferred covalent bonds are carbon to carbon bonds and/or carbon to nitrogen bonds and are more preferably saturated bonds, for example a C—N single bond.

The reactive sites may be intrinsic to the particle surface itself in which case no pre-treatment may be required to use the substrate in the process of the invention. Alternatively, or as well, reactive sites may be added in the form of another material comprising such reactive sites and which is added onto the particle surface e.g. as a coating. The advantage of using a material with reactive sites is that this allows a much wider variety for choice of the underlying particle.

Therefore preferably the process comprises the further step (a1) before step (a) of applying and fixing a material to particles, the material comprising reactive sites. More preferably the material is a coating composition and/or a gel. Preferably the material is polymerisable and step (a1) also comprising a step of polymerising the material in situ on the substrate to form a coating thereon. More preferably said coating comprises reactive sites which have survived the polymerisation process, most preferably in sufficient concentration to strongly link an organic species thereto sufficient for use in a multi-reactive system such as a particle taggant.

Optionally more than one taggant can be attached to the or each particle(s) simultaneously and/or sequentially to obtain a multi-tagged particle(s), although a single information tag (one sequence) is preferred.

Multi-tagged particles of the invention can also comprise a series of many (preferably small or micro-sized) functionalised particles (optionally surface-Functionalised particles) each of which (and/or of groups of which) may react differently to the environment due to the nature of the reactive site and/or probe and/or specific combination(s) and/or mixture(s) thereof. For example each substrate may comprise only one type of site and probe fixed thereon (homogeneously reactive) although each (or each group of) substrate(s) is different. Information may derived from statistical analysis and/or isolating particles having selected properties (e.g. the number and/or distribution of particles having certain properties can be measured and/or certain particles can be collected). Such particle mixtures can be formed together by being prepared in situ and/or may comprise a plurality of separately prepared particles which are subsequently mixed together in the desired proportions before use. A specific example of a system of this second type is particulate mixture (such as functionalised glass beads) where each particle (or group of particles) has an different taggant or combinations of taggant fixed to its surface so each particle (or group of particles) can be identified in a slightly different manner which adds complexity to the article to be tagged thus further deterring copying.

For convenience the term “integer” is used below refers to integers of and/or used the invention as described herein and comprises any of the following: reactive sites, first species thereon (i.e. taggants and/or component of taggants); second species (i.e. means to chemically detecting the taggant rather than by radiation); and/or optional species connecting the first species to the second species. Thus each integer may be applied to and/or exist on, one or more substrates herein substantially uniformly thereon and/or at specific predefined locations thereon (for example applied by a location specific means such as means to directed a carrier droplet e.g. a ink jet printer).

To achieve differential properties of a multi-tagged system comprising a multitude of different substrates (such as functionalised beads). The integers can be applied (or exist) on any one particle uniformly (although one or more integers could still be patterned thereon if desired) but can exhibit different properties between each particle (and/or group of particles). This can be achieved by separate treatment of each particle (and/or group of particles). (e.g. using of different integers and/or reaction conditions at any stage) and subsequent mixing of the different particles. Alternatively or as well process conditions may be varied and/or intrinsic variations in the properties of the particle population may be used (e.g. particle shape and/or size distributions) to create a particle population with the desired variation in properties. The latter may be preferred as multiple particles could be treated together to avoid a subsequent mixing step. Thus a multi-reactive system can also be provided having the desired differential properties but by virtue of the variation of properties across a population.

Tagged particles may be prepared from a material (such as coating or gel) comprising and/or applied to the surface of a substrate, said material comprising reactive sites. An organic species (such as an organic molecule) comprising chemical groups reactive with said reactive sites may thereafter be strongly linked (preferably covalently linked) with said material by means of an suitable reaction. Preferably the material is polymerised in situ on the substrate to which it is attached (or which it forms) such that after polymerisation sufficient reactive sites remain to strongly link the organic species thereto. It is also possible that the material comprises molecules comprising said reactive sites. The material may also be grafted onto the substrate and/or may form part of the substrate surface (i.e. the substrate inherently comprises the reactive sites without the need for further coating).

It is also possible to have reactive sites on the substrate which are capable of reacting with a polyfunctional (preferably di-functional) linking species to form another reactive site at the same location which may be the same as or different from the first. For example an hydroxy functional site on the substrate may react with an isocyanate group on a urethane (meth)acrylate to give a new reactive site with a free (meth)acrylate moiety thereon linked to the surface of the substrate through the linking urethane (meth)acrylate. Substrates functionalised in this manner also comprise the present invention and may also be used as described herein.

Preferably the reactive sites comprise either activated unsaturated moieties or species reactive therewith (i.e. functional groups capable of reacting with activated unsaturated moieties as defined herein, to form a strong link also as defined herein). Such species reactive with activated unsaturated moieties are also referred to herein as “activated unsaturated complements”. Thus the material on the substrate may comprise either activated unsaturated moieties or activated unsaturated complements. The species (such as an organic molecule) strongly linked thereto may then comprise respectively either corresponding activated unsaturated complements or corresponding activated unsaturated moieties. For activated unsaturated moieties suitable reactions which may be used to provide a strong link with activated unsaturated complements comprise addition reactions. Where the activated unsaturated moiety comprises an unsaturated ester moiety such reaction(s) may comprise the well known Michael addition reaction.

Advantageously the particle to be tagged is first coated with a polymerisable composition containing an activated unsaturated moiety or complement thereof (as defined herein). The coating is polymerised in a second step, in such a manner that the activated unsaturated moiety or its complement remains on the coating. In a third step, the coated particle is made to react with an organic molecule comprising groups reactive with the respective activated unsaturated complement or activated unsaturated moiety in an addition reaction.

Accordingly a further aspect of the present invention provides a process for preparing a particle with security tagged the process comprising the steps of:

(a) applying one or more first species (e.g. molecule taggant) optionally dispersed in a carrier medium to a particle having a plurality of reactive sites thereon and/or a plurality of particles having at least one reactive site thereon;

(c) reacting the or each first species (e.g. molecule taggant) with one or more reactive site(s) on the particle(s) to strongly link the or each first species (e.g. molecule probes) thereto,

to form one or more functionalised substrate(s), characterised in that one or more reactive site(s) comprise one or more activated unsaturated moiet(ies) and/or complement(s) thereof; and

one or more first species (e.g. molecule taggants) are reactive with respectively said complement(s) of activated unsaturated moiet(ies) and/or said activated unsaturated moiet(ies).

A still other aspect of the present invention provides a multi-reactive system comprising one or more functionalised particles as described herein having first species and/or molecular taggants deposed thereon.

A yet further aspect of the present invention provides a process for using a multi-reactive system the process comprising the step of applying to one or more functionalised particle(s) of the invention as described herein, one or more second species (e.g. taggant detectors) optionally dispersed in one or more carrier media.

As used herein the second species preferably denotes a taggant detection species (and/or component(s) thereof), more preferably an informational molecule, most preferably a protein, peptide and/or nucleic acid.

Suitable nucleic acids comprises strands of DNA and/or RNA which comprise a plurality (preferably at least eight) of base pairs and/or codons.

Suitable proteins and/or peptides comprises a plurality (preferably at least eight) of any amino acids in sequence.

If the taggant is an informational molecule it comprises sufficient elements (preferably at least eight) which thus make an accidental copy of the same sequence statistically improbable.

So particles can be prepared as describe herein with a specific molecule attached which is chosen to provide a unique label which can identify the particle and an article containing the particle as authentic. The presence of such tagged particles in a article are difficult for a counterfeiter to detect if not forewarned yet easy to monitor for the correct informational sequence it already known. Even it the a counterfeiter is aware of the presence of a tag, such tagged particles are very difficult for a counterfeiter to easily reproduce. An informational molecule of suitable length contains so many permutations of its elements that even were a forger was to detect the present of a biotag and attempt to mimic it he would be unable to select the correct combination.

A yet still other aspect of the present invention provides a process for preparing security tagged particles comprising the steps of:

(a) applying to one or more particle(s) having unsaturated ester moiet(ies) and/or complement(s) thereof, optionally in a pattern thereon, at least one taggant species reactive with the unsaturated ester moiet(ies) and/or complement(s) thereof;

(b) reacting (optionally in an addition reaction) at least one of the taggant species, with the unsaturated ester complement(s) and/or unsaturated ester moiet(ies) in situ on the particle to strongly attach the reactive species thereto;

to form a tagged particles.

Preferably the taggant comprises a DNA sequence, more preferably having at least 8 bases (base pairs when a single strand is hybridised) ; most preferably from 10 to 30 bases, for example about 25 bases.

Preferably the activated unsaturated moiet(ies) and/or complement(s) thereof are deposited homogeneously on the surface of the particles.

Another aspect of the present invention may provide a method of preparing tagged particles in which particles may be coated with a polymerisable composition containing one or more activated unsaturated moiet(ies); the coating may then be polymerised in a manner so the activated unsaturated moiet(ies) remain on the coating; and in an optional further step, the coated particles may then react with an organic molecule comprising groups reactive with the activated unsaturated moiety in an addition reaction.

A further aspect of the present invention may provide particles comprising organic molecules strongly linked to the surface thereof through an activated unsaturated addition reaction, optionally the organic molecules being arranged and/or deposed thereon in a pattern.

Throughout this specification, the term “activated unsaturated moiety” is used to denote an species comprising at least one unsaturated carbon to carbon double bond in chemical proximity to at least one activating moiety. Preferably the activating moiety comprises any group which activates an ethylenically unsaturated double bond for addition thereon by a suitable electrophillic group. Conveniently the activating moiety comprises oxy, thio, (optionally organo substituted)amino, thiocarbonyl and/or carbonyl groups (the latter two groups optionally substituted by thio, oxy or (optionally organo substituted) amino). More convenient activating moieties are (thio)ether, (thio)ester and/or (thio)amide moiet(ies). Most convenient “activated unsaturated moieties” comprise an “unsaturated ester moiety” which denotes an organo species comprising one or more “hydrocarbylidenyl(thio)carbonyl(thio)oxy” and/or one or more “hydrocarbylidenyl(thio)-carbonyl(organo)amino” groups and/or analogous and/or derived moieties for example moieties comprising (meth)acrylate functionalities and/or derivatives thereof. “Unsaturated ester moieties” may optionally comprise optionally substituted generic α,β-unsaturated acids, esters and/or other derivatives thereof including thio derivatives and analogs thereof.

Preferred activated unsaturated moieties are those represented by Formula 1.

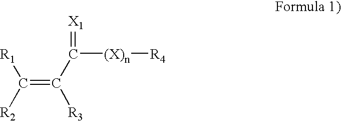

where

n is 0 or 1,

X¹ is oxy or, thio

X² is oxy, thio or NR₅ (where R₅ represents H or optionally substituted organo),

R₁, R₂, R₃ and R₄ each independently represent H, optionally substituents and/or optionally substituted organo groups; and

all suitable isomers thereof, combinations thereof on the same species and/or mixtures thereof.

In will be appreciated that the terms “activated unsaturated moiety”; “unsaturated ester moiety” and/or Formula 1 herein may represent a discrete chemical species (such as a compound, ion, free radical, oligomer and/or polymer) and/or any part(s) thereof. Thus Formula 1 may also represent multivalent (preferably divalent) radicals. Thus the options given herein for n, X¹, X², R₁, R₂, R₃, R₄ and R₅ also encompass corresponding bi or multivalent radicals as appropriate.

More preferred moieties of Formula 1 (including isomers and mixtures thereof) are those where n is 1; X¹ is O; X² is O, S or NR₅;

R₁, R₂, R₃, and R₄ are independently selected from: H, optional substituents and optionally substituted C₁₋₁₀hydrocarbo, and

where present R₅ is selected from H and optionally substituted C₁₋₁₀hydrocarbo.

Most preferably n is 1, X¹ is O; X² is O or S and R₁, R₂, R₃ and R₄ are independently H, hydroxy and/or optionally substituted C₁₋₆hydrocarbyl.

For example n is 1, X¹ and X² are both O; and R₁, R₂, R₃ and R₄ are independently H, OH, and/or C₁₋₄alkyl.

For moieties of Formula 1 where n is 1 and X¹ and X² are both O then:

When one of (R₁ and R₂) is H and also R₃ is H, Formula 1 represents an acrylate moiety, which includes acrylates (when both R₁ and R₂ are H) and derivatives thereof (when either R₁ or R₂ is not H). Similarly when one of (R₁ and R₂) is H and also R₃ is CH₃, Formula 1 represents an methacrylate moiety, which includes methacrylates (when both R₁ and R₂ are H) and derivatives thereof (when either R₁ or R₂ is not H). Acrylate and/or methacrylate moieties of Formula 1 are particularly preferred.

Conveniently moieties of Formula 1 are those where n=1; X¹ & X²=O; R₁ and R₂ are independently H, methyl or OH, and R₃ is H or CH₃.

More conveniently moieties of Formula 1 are those where n=1; X¹ & X²=O; R₁ is OH, R₂ is CH₃, and R₃ is H, and/or tautomer(s) thereof (for example of an acetoacetoxy functional species).

Most convenient unsaturated ester moieties are selected from: —OCO—CH═CH₂; —OCO—C(CH₃)═CH₂; acetoacetoxy, —OCOCH═C(CH₃)(OH) and all suitable tautomer(s) thereof.

It will be appreciated that any suitable moieties represented by Formula 1 could be used in the context of this invention such as other reactive moieties.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl radical). Preferred optional substituents comprise: carboxy, sulpho, hydroxy, amino, mercapto, cyano, methyl and/or methoxy.

The terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclic groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group herein may be selected from: hydrogen, phosphorus, nitrogen, oxygen silicon and/or sulphur, more preferably from hydrogen, nitrogen, oxygen and/or phosphorous.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise saturated, unsaturated and/or aromatic moieties. Hydrocarbo groups may comprise one or more of the following groups. Hydrocarbyl groups comprise univalent groups formed by removing a hydrogen atom from a hydrocarbon. Hydrocarbylene groups comprise divalent groups formed by removing two hydrogen atoms from a hydrocarbon the free valencies of which are not engaged in a double bond. Hydrocarbylidene groups comprise divalent groups (represented by “R₂C═”) formed by removing two hydrogen atoms from the same carbon atom of a hydrocarbon, the free valencies of which are engaged in a double bond. Hydrocarbylidyne groups comprise trivalent groups (represented by “RC≡”), formed by removing three hydrogen atoms from the same carbon atom of a hydrocarbon the free valencies of which are engaged in a triple bond. Hydrocarbo groups may also comprise saturated carbon to carbon single bonds; unsaturated double and/or triple carbon to carbon bonds (e.g. alkenyl, and/or alkynyl groups respectively) and/or aromatic groups (e.g. aryl) and where indicated may be substituted with other functional groups.

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable or effective.

Preferably any of the organo groups listed herein comprise from 1 to 36 carbon atoms, more preferably from 1 to 18. It is particularly preferred that the number of carbon atoms in an organo group is from 1 to 10, especially from 1 to 4 inclusive.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The term ‘effective’ (for example with reference to the process, uses, products, materials, compounds, monomers, oligomers, polymer precursors and/or polymers of the present invention) will be understood to denote utility in any one or more of the following uses and/or applications: preparation and/or use of a micro-array device and/or component thereof such as a functionalised substrate (preferably for the purpose of chemical analysis and/or synthesis) and/or use of the products and/or results obtained directly and/or indirectly therefrom; and/or any other uses described herein.

Such utility may be direct where the material has the required properties for the aforementioned uses and/or indirect where the material has use as a synthetic intermediate and/or diagnostic tool in preparing materials of direct utility. As used herein the term “suitable” denotes that a functional group is compatible with producing an effective product.

The substituents on the repeating unit may be selected to improve the compatibility of the materials with the polymers and/or resins in which they may be formulated and/or incorporated for the aforementioned uses. Thus the size and length of the substituents may be selected to optimise the physical entanglement or interlocation with the resin or they may or may not comprise other reactive entities capable of chemically reacting and/or cross-linking with such other resins.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, interstitial compounds, ligand complexes, organometallic complexes, non-stoichiometric complexes, solvates and/or hydrates); isotopically substituted forms, polymeric configurations [such as homo or copolymers, random, graft or block polymers, linear or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; combinations thereof and/or mixtures thereof. The present invention comprises and/or uses all such forms which are effective.

One feature of the invention is a coating bearing activated unsaturated moieties therein to bind a DNA and/or other biomolecules onto the surface of a particle. From a practical perspective, there exist many ways to introduce increasing amounts of activated unsaturated moieties onto a particle. According to the invention, all processes and methods by which such functions can be made available at the surface of a particle are suitable.

Two methods that are preferred for use as, in and/or with the present invention to obtain particles containing free activated unsaturated moieties are now described.

In one of these methods the particles used as, in and/or with the present invention are those obtained and/or obtainable from compositions containing one or more polymer precursor(s) comprising activated unsaturated moiet(ies) as the sole polymerisable group. The polymer precursor(s) may comprise any monomer(s), oligomer(s) and/or prepolymer(s), alone and/or in admixture. These compositions may be cured in any suitable manner which gives the polymers comprising them a sufficient number of free (i.e. reactive) activated unsaturated moiet(ies) to be useful as a functionalised coating.

An alternative method which may be used to prepare particles used as, in and/or with the present invention comprises polymer precursor(s) comprising functional groups capable of reacting with another functional group of a compound comprising activated unsaturated moiet(ies) (such as (meth)acrylate moiet(ies)). For example, a polymer precursor comprising hydroxy groups can be reacted with acryloyl chloride, or a polymer precursor comprising carboxy groups can be reacted with glycidyl(meth)acrylate. Polymer precursors comprising (meth)acrylate moiet(ies) as the sole chemically polymerisable moiety may also be cured in a manner to give polymers comprising free (meth)acrylate moiet(ies) after polymerisation.

Many different polymers are suitable as polymer precursor(s) and/or polymer coating(s) used as, in and/or with the present invention such as any of the following and/or any mixtures thereof, copolymers thereof and/or combinations thereof in the same species: polyurethane (meth)acrylates, (meth)acrylic (meth)acrylates, polyester (meth)acrylates, epoxy (meth)acrylates, dendritic and/or hyperbranched polyester (meth)acrylates and/or polyurethane acrylates, silicone (meth)acrylates and/or (meth)acrylated amines.

Compositions able to produce suitable polymers (such as those described herein) are any of those well known in the art and preferably belong to the technical field known as radiation curable (radcure) compositions. Effective compositions can exist in any suitable physical and/or form, such as: dispersions, solutions and/or emulsions with for example water and/or organic solvent as the continuous phase; and/or compositions without any water or organic solvent (such as mixtures and/or solid solutions of the polymer precursor(s)). Emulsions may comprise any suitable continuous phase (such as water-in-oil (w/o), oil-in water (o/w) emulsions) and optionally the dispersed phase may also comprise an emulsion (such as water-in-oil-in-water (w/o/w) and/or oil-in-water-in oil (o/w/o) emulsions).

Further suitable polymers and/or compositions comprise those listed in “Surface Coatings Technology,” Volume II—Prepolymers and Reactive Diluents—Chemistry & Technology of UV and EB Formulation for Coatings, Inks and Paints, edited by G. Webster and published by Wiley(1997) which is hereby incorporated by reference.

Polymerisation may be initiated by any suitable means that can be used to obtain polymer coatings used as, in and/or with the present invention such as those coatings comprising free activated unsaturated moieties. There are two preferred polymerisation initiation methods, thermally and/or by irradiation. (such as UV or electron beam radiation). Compositions suitable for thermal polymerisation may comprise a thermal initiator. Polymerisation can also occur under ultraviolet irradiation, and then a photo-initiator is generally present in the composition to aid polymerisation. Electron beam irradiation can also be used.

The quantities of remaining unreacted free activated unsaturated moiet(ies) (such as free (meth)acrylate) may be regulated by the conditions of the polymerisation, such as the temperature, the irradiation dose, the type and quantity of initiator, etc, for example as described in Kinetic Study of Ultrafast Photopolymerization Reactions, C. Decker, B. Elzaouk, D. Decker, J. M. S.—Pure Appl. Chem., A(33), pp. 173-1790 (1996) the contents of which are hereby incorporated herein by reference.

Another route which may be used to prepare particles of the present invention uses coating compositions comprising any polymer precursor(s) (such as monomer(s), oligomer(s) and/or prepolymer(s)) alone or in admixture, at least one of which comprises at least one chemical reactive group(s) capable of polyaddition thereto. Activated unsaturated moieties may also be present in at least one of these polymer precursor(s). Alternatively polymer precursor(s) comprising chemical reactive groups capable of polyaddition thereto may be reacted to form polymer precursor(s) comprising substantially no (meth)acrylate moiet(ies) but which also still comprise reactive group(s) which may then react with other activated unsaturated moiet(ies).

For example, polyurethane polymers (such as those in solvent and/or water dispersions) may be prepared by reacting polyols and poly-isocyanates. Free (meth)acrylate moiet(ies) may thus be incorporated in the polymer as (meth)acrylated alcohols and/or (meth)acrylated polyols, for example by end-capping of isocyanate terminated polymer precursor(s) (which optionally may be fully or partially chain-extended) and/or as component(s) of the polymer precursor itself (which also optionally may be fully or partially chain-extended).

The same and/or similar method(s) described herein may be used to prepare dendritic and/or hyper-branched hydroxy compounds (such as alcohols and/or polyols) comprising a plurality of (meth)acrylate moiet(ies). The incorporation of such hydroxy compounds in a polyurethanes may produce coatings having a high concentration in free (meth)acrylate moiet(ies).

In another preferred feature of and/or used in the invention, the coating comprises polymer(s) obtained by the reaction of reactive groups other than activated unsaturated moiet(ies). In such a case it is straightforward to control the amount of activated unsaturated moiet(ies) on the coating, as this directly depends on the concentration of activated unsaturated moiet(ties) in the initial coating composition.

Any suitable substrate of the invention as described herein can be used to make micro-arrays according to the invention. Preferred substrates comprise glass and/or plastics such as polycarbonate (PC), polyester (PE), polyolefins (such as polypropylene (PP)) and/or polyethylene terphthalate (PET). Optionally such substrates may be pre-treated (for example by treatment with a high voltage corona discharge) in order to promote adhesion and then may be treated as described herein.

The organic species used the taggant(s) to be fixed to the substrate(s) of the invention may comprise any species suitable for the end use to which the tagged particles will be put. Preferably the organic species comprise molecules comprising groups reactive with the preferred functionalised particles of the invention (such as those comprising activated unsaturated moieties or activated unsaturated complements). Preferably the particle surface comprises one or more activated unsaturated moiet(ies) and the probe comprises one or more activated unsaturated complement(s).

Preferred activated unsaturated complement(s) comprise moiet(ies) comprising one or more different hydroxy and/or amino group(s); more preferably amino group(s).

Without wishing to be bound by any mechanism, it is believed that activated unsaturated complements comprise chemical groups which readily covalently bond to activated unsaturated moieties preferably by means of addition reactions. Where the activated unsaturated moiety comprises an unsaturated ester a suitable addition reaction may comprise the well known Michael addition reaction. Preferably such reactions takes place at room temperature during the micro-array manufacturing process. More preferably the reaction occurs between for example an amino comprising species deposited onto the substrate and an unsaturated (hydrocarbylidene) group of an unsaturated ester moiety (such as those comprising (meth)acrylate moiet(ies)) available at the surface of the functionalised substrate.

Preferred organic probes are biomolecules, more preferably DNA, most preferably those containing amino groups. Amino groups are widely widespread reactive groups typically found on biomolecules. In one example of a method of the invention an amine-terminal DNA sequence may be deposited onto a substrate by any suitable method (such as micro-spotting and/or ink jet printing) to react with unsaturated (meth)acrylate moiet(ies) arranged on the substrate in a pre-determined pattern (such as a micro-array).

Articles to be Authenticated

Preferably the article of the present invention which also comprise the tagged particles is selected from a flat article or document such as: security film, security tag, label, packaging, brand, trademark, logo, currency note, cheque, share certificate, stamp and official document; or from three dimensional articles.

More preferably an article of the present invention is associated with, attached to and/or comprises an article selected from at least one of the group consisting of:

antique objects;

audio and/or visual goods for example blank and/or pre-recorded media in any format (e.g. compact disks, audio tapes and/or video tapes);

chemical products for example pesticides, cleaning products, washing powders and/or detergents;

tobacco products for example cigarettes, cigars, and/or tobacco goods;

clothing articles for example leather articles;

soft and/or alcoholic beverages for example wines or spirits;

entertainment goods for example toys and/or computer games;

foodstuffs for example tea, coffee, meats, fish, caviar and/or delicatessen produce,

electrical and electronics parts for example computers and/or spare parts therefor,

electronic objects and/or computer software,

high technology machines and/or equipment;

jewellery for example watches;

leisure items for example binoculars and/or telescopes;

perfumes and/or cosmetics for example shampoos, soaps, perfumes, deodorants, body lotions, creams, toothbrushes, toothpastes, razors and/or razor blades;

products related to or for the treatment, diagnosis, therapy and/or propylaxis of humans and/or animals, for example dental, medical and/or surgical equipment, blood transfusion pouches, medical infusion pouches, packaging for donated organs, osmotic bags, personal health equipment (e.g. optical glasses and/or sunglasses) and/or pharmaceutical products (e.g. in any suitable form for application for example pills, tablets, syrups and/or lotions);

military equipment for example guns, gun sights, ammunition, rockets, military clothing, foodstuffs, gas-masks, mines, grenades and/or ordinance;

photographic industry goods for example cameras and/or pellicles;

scientific instruments and spare parts therefor, for example microscopes, chromatographic apparatus, spectrometric and/or nuclear magnetic resonance apparatus;

machinery and spare parts for the transport industry for example parts for automotive, aerospace and/or aeronautical industry goods, cars, lorries/trucks, motorcycles, space vehicles, rocket ships, vehicle's windscreen stickers, tax discs, trains, coaches and buses, aeroplanes, tubes, trams, helicopters, deep sea exploration equipment, submarines, ships, boats, liners and/or merchant vessels;

travel goods for example luggage;

security documents and/or security goods whether for official documents issued by governments and other official institutions, such as bank notes, bonds, share certificates, stamps, tax receipts, official records, diplomas, identification documents and the like and/or documents issued by commercial institutions such as security tags, labels, tickets, security badges, credit cards, cheques and the like.

sports articles for example sport shoes, tennis rackets, squash rackets and/or equipment for fishing, golf, climbing, skiing, shooting and/or scuba or other deep-sea diving;

any article which has utility in one or more of the uses to which the aforementioned articles may be used, and

any other article which is suitable for attachment to (e.g. as a security label and/or tag) and/or association with (e.g. comprising the packaging) to any of the aforementioned articles.

Sheets

Preferably tagged particles of the invention are incorporated into a self supporting sheet like substrate such as membranes, films, layers, laminates, webs, vellums, pellicles, skins, matrices, mats, veils, weaves, coatings, additives, impregnates, composites, and similar terms, mixtures and/or combinations thereof whether synthetic or natural which may be suitable for the uses described herein for example as packaging, as labels and/or as security documents which may have need of a security and/or tracking feature.

Suitable materials from which to make the sheets include polypropylene (e.g. BOPP), polyethylene, polyolefin, polyester PVC, cellulose and/or polylactic acid. Suitable uses of such sheets include as documents, synthetic paper, labels, graphic art displays, print receptive substrates (e.g. using conventional printing methods such as screen, flexographic, gravure, offset etc and/or digital printing methods such as inkjet printing, thermal image transfer and/or electrorepography), food packaging, lidding, overwrap, stretch wrap, shrink wrap and/or for tamper evidence. The films may be supplied in any suitable form e.g. as roll stock and/or sheets.

Preferred sheets for use herein are films made from thermoplastic polymers and/or biopolymers which may be coated, metallised or otherwise conventionally treated.

Thermoplastic Films Such as BOPP

The thermoplastic polymer film forming the substrate layer is preferably a polyolefin polymer film and more particularly is a molecularly oriented polyolefin polymer film. By a polyolefin polymer film we mean a film which is substantially composed, e.g. from 90 to 100% by weight on the total weight of the film, of at least one polyolefin polymer.

The polyolefin polymer film preferably comprises and may consist essentially of a propylene polymer layer comprising a polypropylene homopolymer or a propylene-olefin copolymer.

Preferably, the polyolefin film comprises a layer which is substantially composed, e.g. from 90 to 100% by weight on the total weight of the layer, of a polypropylene homopolymer or a propylene-olefin block copolymer containing up to 15% by weight, on the total weight of the copolymer, of monomer residues derived from at least one other copolymerisable olefin, such as ethylene. The number average molecular weight (Mn) of the propylene polymer forming the layer is typically in the range of from 20,000 to 200,000, preferably in the range of from 30,000 to 100,000 and particularly in the range of from 40,000 to 80,000. In a preferred embodiment, the propylene polymer layer comprises an isotactic polypropylene homopolymer and more particularly comprises from 90 to 99% by weight, of an isotactic polypropylene homopolymer and from 1 to 10% by weight, of a polydicyclopentadiene resin or some other resin able to increase some or all of the desirable properties of a film such as clarity, gloss and barrier performance.

Of particular interest as a substrate layer are polymeric films which themselves comprise a composite, multi-layer structure. For example, a preferred substrate layer is a multi-layer polymer film including a central or core layer comprising a propylene polymer, which is preferably a polypropylene homopolymer or a propylene-olefin copolymer as described above, and first and second outer layers formed on opposed surfaces of the core layer comprising an olefin polymer which has better adhesion to the subsequently applied layers than the polymer of the core layer.

Suitable outer layers comprise and preferably consist essentially of an essentially olefinic polymer, such as an ethylene-propylene block copolymer, an ethylene-mono alpha olefin random copolymer containing from 1 to 15% by weight on the weight of the copolymer of mono alpha olefin monomer residues which contain from 3 to 10 carbon atoms, or a blend of such polymers. A preferred material for the outer layer is a linear low density ethylene polymer, e.g. a linear polymer of ethylene and optionally a higher olefin comprising from 90% to 100% by weight of ethylene monomer residues on the total weight of the polymer, having a density in the range of from 0.91 to 0.94 g/cc.

A particularly preferred core layer for the multi-layer substrate film described above, is one comprising an isotactic polypropylene homopolymer and more particularly one comprising from 90 to 99% by weight, of an isotactic polypropylene homopolymer and from 1 to 10% by weight, of a polydicyclopentadiene resin based on the total weight of the core layer.

When the substrate layer is a three layer film as described above, the core layer will preferably constitute from 70 to 98% of the total thickness of the film with the two outer layers constituting the remainder and typically being of substantially equal thicknesses.

Other suitable polymer films for the substrate layer may be composed of non-hydrocarbon polymers, e.g. polyesters such as polyethylene terephthalate (PET) and polyamides (nylons).

A polyolefin polymer film for the substrate layer may be fabricated using any of the techniques known in the art for the production of films, but is most conveniently prepared using an extrusion process.

Formation of a multi-layer film for the substrate layer may be effected by any of the laminating or coating techniques employed in the films art. Preferably, however, the outer layers are applied to the base or core layer by a coextrusion technique in which the polymeric components of the core and outer layers are coextruded into intimate contact while each is still molten. Preferably, the coextrusion is effected from a multi-channel annular die such that the molten polymeric components constituting the respective, individual layers of the composite substrate merge at their boundaries within the die to form a single composite structure which is then extruded from a common die orifice in the form of a tubular extrudate.

The substrate film of the invention is preferably oriented by stretching at a temperature above the glass transition temperature of the polymer(s). For example, orientation of a substrate film having a propylene polymer layer (whether on its own or as part of a multi-layer structure) is conveniently effected at a temperature in a range of from about 145 to 155° C.

Orientation may be effected uniaxially, by stretching the film in one direction, or biaxially, by stretching the film in each of two mutually perpendicular directions in the plane of the film. Where the film is biaxially oriented, this orientation may be balanced or unbalanced, for example with the higher degree of orientation of an unbalanced film in a preferred direction—usually the transverse direction. Conveniently, the substrate film (which may be a single or multi-layer film) is (co)extruded in the form of a tube. This tube is subsequently quenched, reheated, then expanded by internal gas pressure to induce transverse orientation and finally drawn at a rate greater than that at which it was extruded to stretch and orient it in the longitudinal direction. Alternatively, a flat film may be oriented by simultaneous or sequential stretching in each of two mutually perpendicular directions by means of a stenter, or by a combination of draw rolls and a stenter.

The degree to which the film substrate is stretched depends to some extent on the ultimate use for which the film is intended, but for a polypropylene-based packaging film satisfactory tensile and other is properties are generally developed when the film is stretched to between three and ten, preferably, seven, times its original dimensions in each of the transverse and longitudinal directions.

After stretching the polymeric film substrate is normally “heat-set”, while restrained against shrinkage or even maintained at constant dimensions, at a temperature above the glass transition temperature of the polymer and below its melting point. The optimum heat-setting temperature can readily be established by simple experimentation, and for a substrate film having a propylene polymer layer (whether on its own or as part of a multi-layer structure), “heat-setting” is conveniently effected at temperatures in the range of from 100° C. to 180° C. Heat-setting may be effected by conventional techniques, for example, by means of a stenter system, or by a system of one or more heated rollers as disclosed, for example, in GB-A-1124888. Alternatively, or additionally, the film may be subjected to a constrained heat treatment of the kind described in EP-A-23778.

Biopolymeric Films (Such as Cellulose or PLA)

Types of film-forming and/or impregnating biopolymers that may also be authenticated as described herein (after where necessary suitable modification) are described below.

The biopolymers (e.g. bopolymeric films) which may be used in present invention may be obtained and/or obtainable from a biological (preferably plant and/or microbial) source and may comprise those organic polymers which comprise substantially carbon, oxygen and hydrogen. Conveniently biopolymers may be selected from carbohydrates; polysaccharides (such as starch, cellulose, glycogen, hemi-cellulose, chitin, fructan inulin; lignin and/or pectic substances); gums; proteins, optionally cereal, vegetable and/or animal proteins (such as gluten [e.g. from wheat], whey protein, and/or gelatin); colloids (such as hydro-colloids, for example natural hydrocolloids, e.g. gums); other polyorganic acids (such as polylactic acid and/or polygalactic acid) effective mixtures thereof; and/or effective modified derivatives thereof.

Further details of each of these biopolymers are given below.

Starch may comprises native and/or modified starch obtained and/or obtainable from one or more plant(s); may be a starch, starch-ether, starch-ester and/or oxidised starch obtained and/or obtainable from one or more root(s), tuber(s) and/or cereal(s) such as those obtained and/or obtainable from potato, waxy maize, tapioca and/or rice.

Gluten may comprise a mixture of two proteins, gliadin and glutenin whose amino acid composition may vary although glutamic acid and proline usually predominate.

Gums are natural hydro-colloids which may be obtained from plants and are typically insoluble in organic solvents but form gelatinous or sticky solutions with water. Gum resins are mixtures of gums and natural resins.

As used herein the term carbohydrate will be understood to comprise those compounds of formula Cₓ(H₂O)_{y}. which may be optionally substituted. Carbohydrates may be divided into saccharides (also referred to herein as sugars) which typically may be of low molecular weight and/or sweet taste and/or polysaccharides which typically may be of high molecular weight and/or high complexity.

Polysaccharides comprise any carbohydrates comprising one or more monosaccharide (simple sugar) units. Homopolysaccharides comprise only one type of monosaccharide and heteropolysaccharides comprise two or more different types of sugar. Long chain polysaccharides may have molecular weights of up to several million daltons and are often highly branched, examples of these polysaccharides comprise starch, glycogen and cellulose. Polysaccharides also include the more simple disaccharide sugars, trisaccharide sugars and/or dextrins (e.g. maltodextrin and/or cyclodextrin).

Polysaccharides may comprise a polymer of at least twenty or more monosaccharide units and more preferably have a molecular weight (M_{w}) of above about 5000 daltons. Less complex polysaccharides comprise disaccharide sugars, trisaccharide sugars, maltodextrins and/or cyclodextrins.

Complex polysaccharides which may be used as biopolymers to form or comprise films of present invention comprise one or more of the following:

Starch (which occurs widely in plants) may comprise various proportions of two polymers derived from glucose: amylose (comprising linear chains comprising from about 100 to about 1000 linked glucose molecules) and amylopectin (comprising highly branched chains of glucose molecules).

Glycogen (also known as animal starch ) comprises a highly branched polymer of glucose which can occur in animal tissues.

Cellulose comprises a long unbranched chain of glucose units.

Chitin comprises chains of N-acetyl-D-glucosamine (a derivative of glucose) and is structurally very similar to cellulose.

Fructans comprise polysaccharides derived from fructose which may be stored in certain plants.

Inulin comprises a polysaccharide made from fructose which may be stored in the roots or tubers of many plants.

Lignin comprises a complex organic polymer that may be deposited within the cellulose of plant cell walls to provide rigidity.

Pectic substances such as pectin comprise polysaccharides made up primarily of sugar acids which may be important constituents of plant cell walls. Normally they exist in an insoluble form, but may change into a soluble form (e.g. during ripening of a plant).

Polylactic and/or polygalactic polymers and the like comprise those polymeric chains and/or cross-linked polymeric networks which are obtained from, obtainable from and/or comprise: polylactic acid; polygalactic acid and/or similar polymers and which may be made synthetically and/or sourced naturally.

Other types of polysaccharide derivatives one or more of which may also be used in the present invention may comprise any effective derivative of any suitable polysaccharide (such as those described herein) for example those derivatives selected from. amino derivatives, ester derivatives (such as phosphate esters) ether derivatives; and/or oxidised derivatives (e.g. acids).

Preferred biopolymer films used in the present invention are those formed from a biopolymer selected from cellulose, cellulose derivatives (such as cellulose acetate) and/or polylactic acid.

Preferably the cellulose film used in the present invention is cellulose regenerated from a cellulose containing fluid.

The cellulose film may be regenerated by any suitable process. For example chemical regeneration and coagulation (osmotic dehydration) are used in the well known viscose process in which the viscose fluid comprises sodium cellulose xanthate in caustic soda. The dispersed cellulose is cast into film by regenerating the cellulose In situ by treatment of the viscose with dilute sulphuric acid) and extruding the cellulose thus formed. Other known methods for regenerating cellulose use methods such as coagulation, solvent removal and/or formation of a cellulose complex in fluids such as: N-methyl morpholine-N-oxide (NMMO); N-methyl pyrrolidone (NMP) with anhydrous lithium chloride (LiCl); dimethyl acetamide (DMA or DemAc) and/or cuprammonium. Films made by any of these methods are also useful to make sheets of this method.

It will be appreciated that if an impregnated sheet of the invention is desired, the fibre matrix can be added to the cellulose containing fluid in any of the above processes and the cellulose film can be regenerated in situ in the normal manner to produce a fibre matrix impregnated with a cellulose film.

Usefully sheets of the invention may be optionally softened using any suitable conventional softening agent.

Conveniently films used in the present invention substantially comprise cellulose from a wood source, most preferably at least 90% of the cellulosic material is from a wood source.

The sheets of the invention may include one or more plasticisers (preferably non-migratory), but, typically, such plasticisers are not included. Generally the membrane is a porous layer that does not include wettable material coatings, metal coatings or fillers such as, for example, inorganic particles.

Preferably the biopolymeric film, especially if a cellulosic film prepared by the NMMO process, is oriented in the TD and/or MD, optionally at a stretch ratio of 7 to 1.

Further and/or alternative aspects and features of the present invention are described in the claims if not already described herein.

Embodiments

Silica Modification

In one embodiment of the invention for the DNA to be detected after the film has been converted into an article, it is preferred that the DNA is at the surface of the film. One way to do this is to bind the DNA onto silica anti-block particles, then inject them into the outer coat layer of the film. Since DNA will not bind to ordinary silica particles it is first necessary to modify them before the DNA can be immobilised.

One suitable method to modify the silica bead is in two parts. The first part of the procedure is to modify the silica beads with aminopropyltriethoxy silane to create aminopropyl silica beads as shown schematically below: (where R denotes the bead).

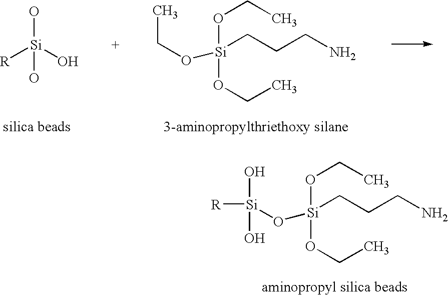

The aminopropyl silica beads are then derivatised with a Polyethylene Glycol (PEG) spacer as shown schematically:

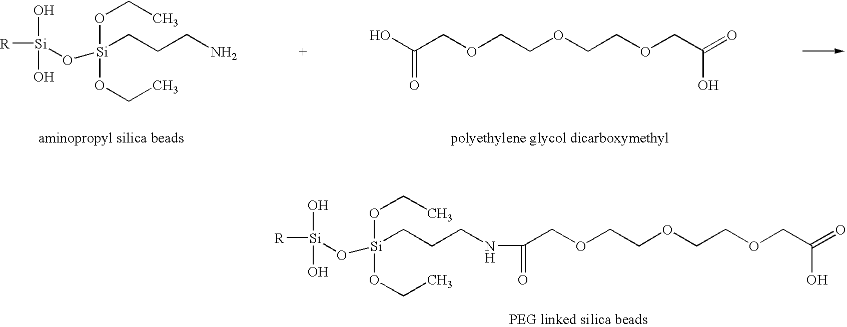

The above reactions may be carried out using standard silica anti-block particles as the starting material. After the modification was complete, the modified silica can be analysed using FTIR, and compared to standard silica. The spectrum clearly indicated that the such modifications are successful, with the ethoxysilane peaks visible at 996 nm and 946 nm, whereas the amide was clearly visible at 3352 nm, 1630 nm and 1520 nm.

The amino aminopropyl silica beads can also be reacted with other reagents to make other functional groups for immobilisation of the DNA. For example succinic anhydride can be used as shown schematically:

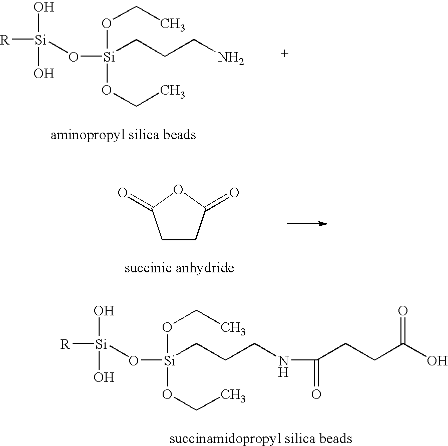

Alternatively 1,4-phenylene diisothiocyanate (PDITC) can be used as shown schematically:

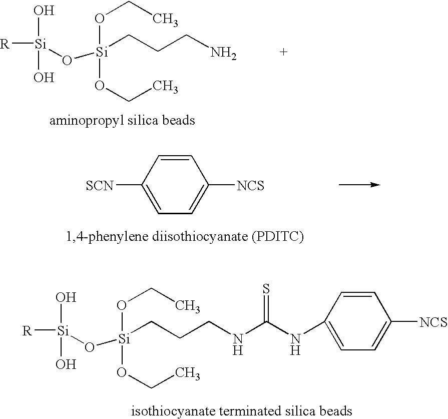

It will be appreciated that many other alternative procedures can be used to modify a silica or other particle surface (to immobilise DNA thereto). Such modifications include those described in the following papers: “M. K Walsh et al, J. Biochem. Biopys. Methods 47 (2001) 221-231”; and/or “Jose, Kuster and Cone, Analytical biochemistry 247 (1997), 96-101”

DNA Immobilisation

The DNA may be immobilised onto the PEG linked Silica by incubating the beads in the presence of a carbodiimide. The terminal amine function on the 5′ end of the DNA reacts with the carboxylic acid as shown schematically:

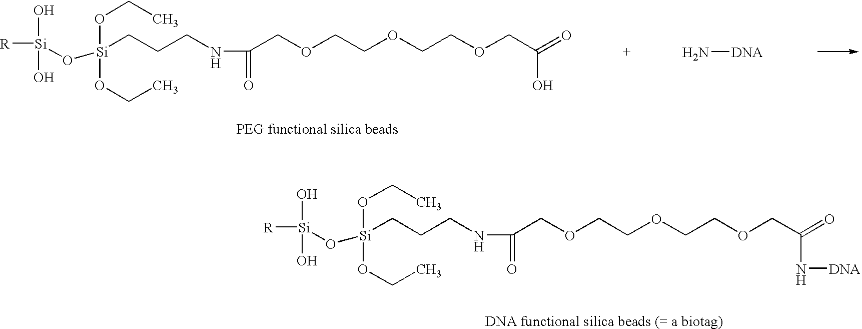

In cases of the succinaminopropyl silica beads the amine terminated 5′ end of the oligonucleotide is also reacted with the newly formed carboxylic acid groups on the derivatised silica as for PEG-linked beads. In the case of method isothiocyanate terminated silica beads the amide is reacted with the isothiocyanate group.

After the reaction is complete, it is necessary to determine if the DNA has successfully been immobilised to the modified silica. This is done by hybridising the corresponding fluorescent probe onto the silica bound DNA, then observing the samples under a fluorescent microscope.

The DNA marked silica (along with a standard silica control) may be first of all heated in a pre-hybridisation buffer, then the fluorescent probe may be added and the mixture heated further. When observed under the fluorescence microscope the standard silica showed no sign of any fluorescence, where as the silica with the DNA bound to it (e.g. using the PEG linked method described above) fluoresced bright red. This is a clear indication that the DNA was successfully immobilised onto the silica.

A further non-limiting embodiment of the invention is described in more detail so the principles of the present invention can be better understood.

Silica particles to be tagged are functionalised with an acrylic group on the surface thereof, for example by the addition reaction of a multi-acrylated alkoxy silane with the hydroxy groups on the surface of the silica particle in a suitable solvent such as methyl ethyl ketone (MEK). Such acrylated silica particles can then be reacted conventionally with polar groups on a taggant to form a particle with taggant molecules covalently bounded thereto. For example a DNA strand with a terminal amino or hydroxy group can reacted in the presence of radiation (e.g. by use of UV or electron beam radiation) and an optionally photo-initiator with the acrylated silica particles (to form silica particles with DNA strands firmly bound to the particle surface.

Such particles can be readily incorporated in an article (for example added to a film during manufacture) and the DNA sequence remains substantially intact. If strands having a long sequence of DNA are attached to the particle (say on average of at least 20 base pairs in length) this allow for some degradation of the DNA during incorporation of the particles in the article and subsequent manufacture, treatment and handling of the tagged article. It is preferred that in the final article on the particles have at their surface DNA strands of an average length of at least eight base pairs to provide sufficiently large number of base pair permutations to guard against a false positive by an incorrectly selected DNA probe.

As the DNA sequence of the tag is known the complementary DNA sequence can be used as a probe to test for the presence of that DNA in the article. The DNA probe may be conventionally applied in any suitable form such as dispersed in a liquid. To counter possible degradation of the surface bound DNA, it is preferred that the probe is matched to the sequence of DNA most closely attached to the particle and preferably of at least eight base pairs long as this is the sequence which is most protected from degradation during manufacture and therefore likely to be present in the greatest numbers for ease of detection.

The DNA is readily accessible as it is disposed at the surface of the particles which are also located throughout the article (including at the surface of the article). Hence the article can be non destructively authenticated by exposure to a liquid with the complementary DNA probe which for example may be radio labelled with a radio isotope of short half life. The article can then readily be confirmed as authentic if it to becomes radio-labelled after washing off excess probe, as the probe will only bind to the correct sequence of DNA.

So in one preferred embodiment of the invention a Biotag is created by binding a single strand of DNA to a modified silica bead. These silica beads can then be incorporated into an article to be marked (such as a film). For cellulose film one method of doing this is to add the silica beads to a lacquer and then coated them onto the film, or alternatively in the case of OPP films the beads can be coated into the film or formulated into the outer coat polymer of the film.

In this embodiment to detect the presence of the Biotag after the film has been sent out, and manufactured into an article, a fluorescent probe is used. To prepare the film for the hybridization it is first washed in a buffer solution before the fluorescent probe is added. After the hybridization procedure is complete the film is washed and then looked at under the microscope.

If fluorescence can be observed, then it means that the film has a Biotag with the correct sequence attached to it. If no fluorescence is seen, then it must mean that there are either no Biotags on the film or that a Biotag is attached to the film but It has the incorrect sequence.

Therefore an embodiment of a method of the present invention can be summarised as the following steps:

Particles of silica (or other suitable material) are modified by any suitable method so DNA can be attached thereto. Methods include by are not limited to those embodiments described herein. A selected base sequence (preferably at least 25 bases in length) of single stranded DNA is Immobilized onto the modified silica to form the Biotag (“lock”). The Biotags are incorporated into a standard production films (such as OPP or cellulose) by any suitable means such as any of those described herein. A validated detection procedure is used to confirm that the Biotags can be detected in the resultant film. The same or a different method can also be used to detected for the presence of the “correct” Biotag in an unknown film (i.e. to authenticate the film). Suitable detection methods include but are not limited to those embodiments described herein. For example the Biotags in the film can be hybridized with a fluorescent Probe (the “key”) with the correct complementary DNA sequence therein for the selected Biotag. Fluorescence on the film indicates an authenticate film.

The present invention is illustrated by the non-limiting Figures herein in which:

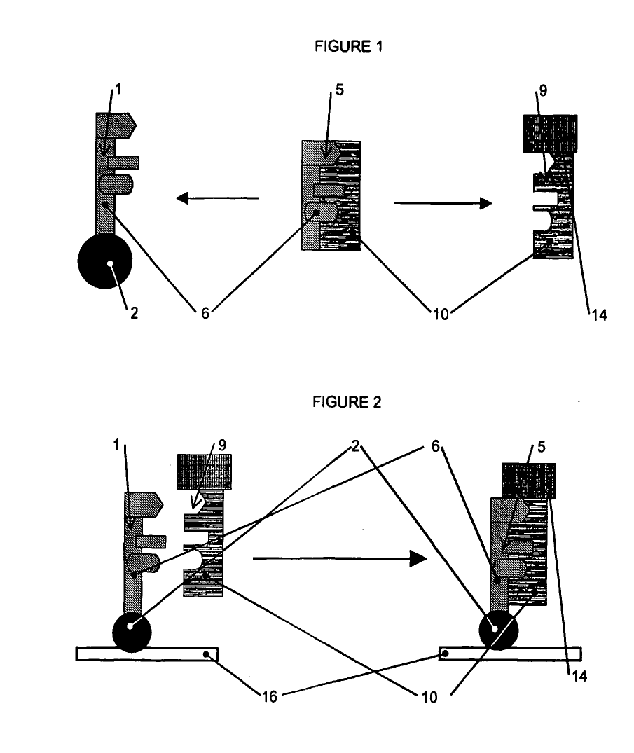

FIG. 1 shows schematically how double stranded DNA formed from the Biotag (“lock”) and the Fluorescent Probe (“key”) can combine.

FIG. 2 shows schematically how correctly marked film with correctly selected probe is authenticated by a positive fluorescent signal.

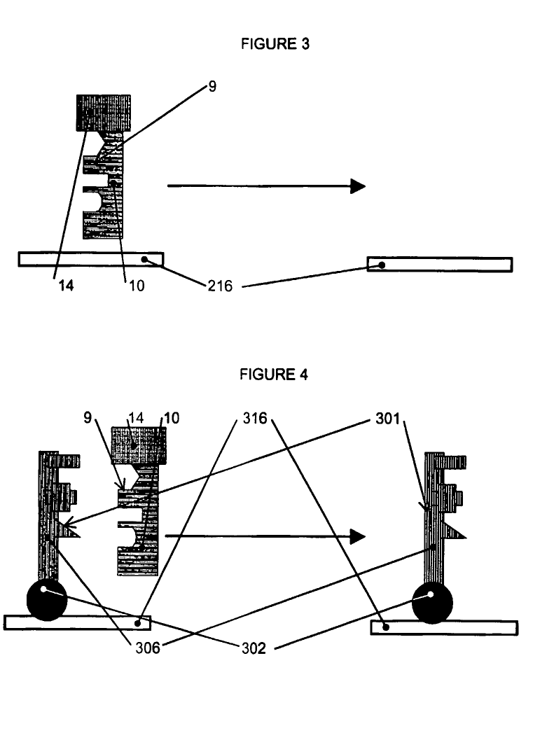

FIG. 3 shows schematically how unmarked film gives no signal with any probe (No lock).

FIG. 4 shows schematically how film marked with alternative DNA (wrong “lock”) does not produce a fluorescent signal with the “correct” probe (right key).

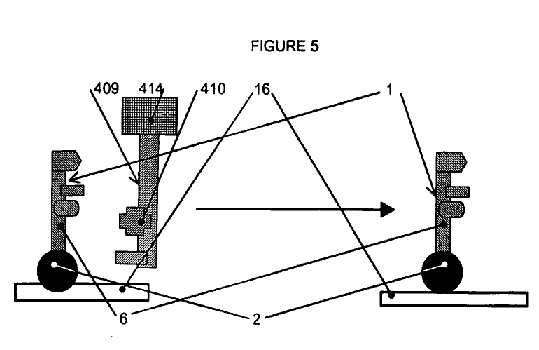

FIG. 5 shows schematically how film marked with the “correct” (i.e. pre-selected) DNA does not produce a fluorescent signal with the “incorrect” probe (wrong key).

Embodiments of films according to the present invention will now be described by way of example with reference to the accompanying Figures. Features in each figure are given number labels with the same feature in each figure being given the same number label. Similar and/or analogous features in each figure are labelled by numbers separated by a whole number multiple of one hundred (i.e. 1, 101, 201 etc).

For convenience the following legend was used in the FIGS. 1 to 5 herein.

1 “Correct” (i.e. selected) Biotag “lock”, generally

2 Silica particle attached to “correct” DNA tag

5 Double stranded DNA, generally (“correct” lock in “correct” key)

6 “Correct” DNA tag

9 “Correct” (i.e. matched to selected lock) fluorescent probe “key”, generally

10 “Correct” cDNA probe

14 Fluorescent marker attached to “correct” probe

16 Correctly tagged film substrate

216 Untagged film substrate

301 Biotag “lock”, generally with “wrong” DNA

302 Silica particle attached to “wrong” DNA

306 “wrong” (i.e. non selected) DNA

316 “Incorrectly” tagged film substrate using “wrong” DNA

409 Fluorescent probe “key”, generally—with “wrong” cDNA

410 “wrong” cDNA probe (i.e. will not complement selected DNA)

414 Fluorescent marker attached to “wrong” cDNA probe.

With reference to FIG. 2 in one embodiment of an authentication method of the invention a film (16) is marked with a Biotag (1) but any suitable method described herein The Biotag (1) has a pre-selected single strand of DNA (6) 25 base pairs long attached to silica particles (2) which are dispersed at the film surface. The tagged film (16) is tested (as described herein) with a Probe (9) comprising a fluorescent marker (14) attached to a single strand of DNA (10) complementary to the pre-selected DNA strand (6) in the Biotag (1). The DNA hybridises and the Probe (9) is attached to the film surface (16). After washing the fluorescent marker (14) can be observed on the film indicating a positive result.

With reference to FIG. 3 it can be seen that the method of the invention will not detect unmarked film. Such a film (216) without any Biotag provides no means for the probe to attach to the film. Hence when the film (216) is exposed to the Probe (9) no DNA hybridisation occurs and the Probe (9) is washed away during the test. No fluorescence is observed on the film indicating a negative result.

With reference to FIG. 4 it can be seen that the method of the invention will not detect film marked with DNA different from the pre-selected sequence. For example a counterfeiter may attempt to add DNA to an article as described herein but will not know which sequence has been selected to indicate an authentic article. The test film (316) is marked with a different Biotag (301) comprising a different single strand of DNA (306) which is not that pre-selected. The tagged film (316) is tested as before with a Probe (9) for the pre-selected DNA. Hybridisation does not occur between the non-complementary DNA strands (306, 10) which do not bind together. Thus the Probe (9) does not attach to the film surface (316) and is washed away during the test. No fluorescence is observed on the film indicating a negative result.

Similarly with reference to FIG. 5 it can be seen that the method of the invention will not detect film marked with the correct “pre-selected” DNA (6) if the wrong Probe (410) is used. For example a counterfeiter might attempt to test for the presence of DNA (to reproduce it) but without selecting the correct probe would not discover the DNA in the film. The test film (16) is marked with the Biotag (1) comprising the single strand of DNA (6) with the pre-selected sequence. The tagged film (16) is tested as before but with a different Probe (409) comprising a fluorescent marker (414) attached to a single strand of DNA (410) which is not complementary to the pre-selected DNA strand (6). Hybridisation does not occur between the non-complementary DNA strands (6, 410) which do not bind together. Thus the Probe (409) does not attach to the film surface (16) and is washed away during the test. No fluorescence is observed on the film indicating a negative result.

### EXAMPLES

The invention will now be illustrated by the following non-limiting examples and tests which are by way of illustration only. The examples comprise two types of formulations (cured thermally or by radiation) which demonstrate and evaluate certain acrylated particles which may be tagged with DNA. In these examples procedures for preparing the reactive particles are described separately from the steps used to attached the DNA taggants. In the examples herein: NCO values or concentration (also denoted herein as I_{NCO}) may be measured using any suitable standard method (such as that described in ASTM D2572-87); hydroxy values or concentration (also denoted herein as I_{OH}) may be measured using any suitable standard method (such as that described in E222-73); acid values or concentration (also denoted herein as I_{H+}) may be measured using any suitable standard method (such as that described in ASTM D 974-64); and/or free acrylate values or concentration (also denoted herein as I_{ACR}) may be measured using any suitable standard method known to those skilled in the art.

Unless otherwise indicated the particular methods used in the examples herein to detect the Biotags (either alone or incorporated into a film) are now described. In both methods a control sample with no DNA bound to it was always included to verify that any fluorescence observed was not caused by non-specific binding of the probe to the surface of the sample. For convenience the film samples to be tested (which were not destroyed by the test) were a samples, small pieces cut to fit into the tube, however it will be appreciated that the methods can be modified so if necessary authentication can occur non destructively in situ for example on a film or article which cannot be sampled.

The first method is a hybridization procedure used to test silica bound to DNA on its own. A sample (1000 μl) of pre-heated (55° C.) of a standard hybridization buffer (available under the trade name “PerfectHyb Plus”) was pipetted into a 1.5 ml centrifuge tube. The sample to be tested was added and the tube was shaken. The tubes were incubate at 56° C. for 30 mins. Then 20 μl of the probe was added to each tube, ensuring that the probe was not added directly onto the sample. The tubes were placed in a hybridization oven for 3 hours at no more than 60° C. The sample was separated from solution and washed twice in a low stringency wash buffer at room temperature for 5 minutes. The sample was separated again and washed with high stringency wash buffer and then twice with ultra high stringency wash buffer, each time the wash was for 20 minutes at 60° C. The washed samples were examined under a fluorescence microscope using Zeiss Filter set number 00, to determine in any fluorescence was seen.

A similar second method was used to detect the silica bound DNA biotags after they have been incorporated into a film. A sample (1000 μl) of pre-heated (55° C.) of a standard hybridization buffer (available under the trade name “PerfectHyb Plus”) was pipetted into a 1.5 ml centrifuge tube. The film samples to be tested were first pre-washed with molecular biology grade water and then added to the tube and the tube was shaken. The tubes were incubate at 56° C. for 10 mins. Then 5 μl of the probe was added to each tube, ensuring that the probe was not added directly onto the sample. The tubes were placed in a hybridization oven for 1 hour at no more than 60° C. The sample was separated from solution and washed twice in a low stringency wash buffer at room temperature for 2 minutes. The washed samples were examined under a fluorescence microscope using Zeiss Filter set number 00, to determine in any fluorescence was seen.

The wash buffers used in the above methods were as follows. The low stringency wash buffer was 500 ml of molecular biology grade water to which 100 ml of SSC and 10 ml of 10% SDC was added. The buffer was then made up to 1 litre with molecular biology grade water. The high stringency wash buffer was 500 ml molecular biology grade water, to which 25 ml SSC and 10 ml 10% SDC were added. The buffer was then made up to 1 litre with molecular biology grade water. The ultra high stringency wash buffer was 500 ml molecular biology grade water, to which 5 ml SSC and 10 ml 10% SDC were added. The buffer was then made up to 1 litre with molecular biology grade water.

Reactive Particle Preparation

Synthesis of Polymer Precursors for Coating

### Example 1

### Synthesis of Hydroxy-Functional Urethane Acrylate

The amount of 444 g of pre-heated 5-isocyanato-1-isocyanatomethyl-1,3,3-trimethylcyclohexane (also known as IPDI and available commercially from Degussa-Huels, Germany) was introduced into a 2 litre four-necked round-bottomed flask equipped with a stirrer, a thermometer, a water cooled condenser and a dropping funnel. The mixture was heated at 45° C. and then 0.37 g of dibutyl tin dilaurate (also known as DBTL and available commercially from Akcros) was added as catalyst. From the dropping funnel 232 g hydroxyethylacrylate and 0.925 g hydroquinone mono methyl ether were slowly added while the temperature of the reaction mixture was maintained at a maximum of 65° C. The mixture was held at this temperature for one hour until I_{NCO} reached 2.96 meq/g. Then 250 g of di-trimethylolpropane (I_{OH} of 898 mg KOH/g) was added while the reaction was further heated at 65° C. until I_{OH} dropped below 0.05 meq/g. The oligomer was cooled at 40° C. and diluted with 927 g of butyl acetate to obtain a 50% aqueous dispersion of the product urethane acrylate having a viscosity of 135 mPas at 25° C.; I_{OH} of 60 mg KOH/g and 1.078 meq/g of free acrylate (I_{OH} of the solid product was 121 mg KOH/g). This dispersion of urethane acrylate was used directly in the formulations described below.

### Example 2

### Synthesis of Polyol

1,6-Hexanediol (1,144.2 g) and adipic acid (1,135.6 g) (both available commercially from BASF), together with a DBTL catalyst (0.02 g), were mixed in a three litre reaction vessel equipped with an agitator, packed column, condenser, thermometer and inert gas inlet. The reaction vessel was flushed with inert gas and the reactants heated to a temperature of 195° C. to 200° C. while the water produced from the esterification was removed. The reaction was continued for five hours until I_{H+} was 5 mg KOH/g and I_{OH} was 117 mg KOH/g, to obtain as product a polyol with Mₙ of 1000 and final I_{OH} of 112 mg KOH/g. This polyol was used directly in the formulations described below.

### Example 3

### Modification of Silica Beads

3(a) Aminopropyl silica functional beads were prepared by washing 60 g of silica beads in distilled water and then added them to 250 ml of a 10% (v/v) aqueous solution of 3-aminopropyl-triethoxysilane which was adjusted to pH 4. After allowing the reaction to proceed for 3 hours at 70° C., the liquid was decanted and the beads were dried at 120° C. overnight. The beads were then washed with distilled water, filtered and used in the next step.

3(b) PEG functional silica beads were prepared from the aminopropyl functional silica beads made as in Example 3(a) by adding 1.5 g of PEG-bis(carboxymethyl)ether (Mₙ˜600) and 5 g EDC to 250 ml 0.1M MES buffer (pH4.5) (19.52 g MES/1000 ml Water). The beads (from Ex 3(a) above) were then added to the mixture which was then stirred for 3 hours at 25° C. The PEG functional beads were then washed with phosphate buffered Saline (PBS), pH 7.2 and dried at room temperature on a fluid bed drier.

### Example 4

### Oligonucleotide Immobilisation on the Functional Beads of Example 3

First 5 g EDC and 180 μg oligonucleotide (200 μl oligo 2, M_{w} 7554.9 g/mol, from ThermoHybaid) in 250 ml 0.1M MES buffer (pH4.5) were directly added to the PEG-functional silica beads from Example 3 and the mixture was incubated at 25° C. for 3 hours. The beads were then washed with molecular biology grade water and dried at room temperature in a fluid bed drier. These DNA tagged silica particles (Biotag) or particles made analogously can be added to films and other articles as described herein to provide an authentication means of the present invention.

Formulation and Coating of Other Particles

Particles

Functionalised substrates of the invention were prepared from commercially available polycarbonate, glass or silica beads. The beads were mixed with one of the formulations described herein until the surface of the beads were well coated. The functionalised beads of the invention were then tagged with DNA as described below.

Coating Formulations

Two types of formulations were used (suitable for radiation or thermal curing) and details are given below of those formulations that were tested.

Radiation Cured Formulations

UV cured formulations of the invention (Examples 5 & 6) are described below in Table 1. The free acrylate content of the cured coating comes from unreacted unsaturated groups present after UV irradiation. The formulations in Table 1 below were UV-cured by being passed at a speed of 20 m/min, four times under a 80W/cm medium pressure mercury lamp. All the ingredients in Table 1 except the photo-initiator were obtained from UCB Chemicals under a trade name if indicated in parentheses.

TABLE 1

% Weight

| Ingredient | Example 5 | Example 6 |
|---|---|---|
| Urethane acrylate (Ebecryl 284) | 40 | 25 |
| Epoxy acrylate (EbecryI 604) | 40 | 25 |
| Hexanediol acrylate | 15 | 45 |
| Benzophenone | 2.5 | 2.5 |
| Photo-initiator (Darocure 1173 | 2.5 | 2.5 |
| from CIBA) | | |

Thermally Cured Formulations

A wide variety of thermally cured formulations of the invention can be formulated as described herein as the concentration of free acrylate desired in the final substrate can be adjusted by increasing or decreasing the concentration of the hydroxy functional urethane acrylate (such as Example 1) in the formulation. For example the two acrylate groups on the urethane acrylate of Example 1 do not participate in thermally induced polymerisation (cross-linking) and remain available after cross-linking. The formulations in Table 2 below (Examples 7 to 10) were thermally cured in an oven for 3 hours at 60° C. The formulations in Table 2 comprised 9% by weight of the aliphatic polyisocyanate available commercially from Bayer under the trade name Desmodur N3300; (91−X)% of the polyol of Example 2 and X% of the urethane acrylate of Example 1; where the values of X are given in Table 2.

TABLE 2

| | | Free acrylate |
|---|---|---|
| Example | X | meq/g |
| 7 | 91 | 0.98 |
| 8 | 45 | 0.49 |
| 9 | 23 | 0.24 |
| 10 | 9 | 0.10 |

Preparation of Other DNA Tagged Beads

The acrylated beads were first tagged with suitable DNA as described below. The DNA tagged beads were then themselves exposed to a radio nucleotide labelled complementary DNA as the detector. This demonstrates that if the tagged beads were incorporated into an article exposure of the article to a sample of the detector DNA probe could readily indicate the present of the security tag.

Preparation of DNA Taggants

The template DNA sequences used for to prepare the nucleotides used as taggants in the tests described herein are those of Cytomegalovirus, which were synthesised according to methods and protocols described by Zammateo et al. in Analytic Biochem 253, pp 180-189 (1997). The MIE4 primer so used comprised an amine group at its 5′ terminus with an amplicon length of 257 base pairs. DNA sequences were amplified using PCR in a conventional manner and then were separated from unincorporated nucleotides and primers by chromatography on a high pure PCR product purification kit (available commercially from Mannheim, Germany). DNA concentration was measured by its absorbance at 260 nm. The aminated DNA capture probe so obtained was added to a buffered solution to keep a substantial proportion of the amino groups on the probe in their unprotonated state (i.e. as NH₂). The buffer solution comprising DNA probes (also known herein as a DNA buffer) was deposited onto the beads as described below. The concentration of the DNA probe in each of the different DNA buffers used herein was 100 nM.

Preparation of Labelled DNA to be Used as the Detector.

Cytomegalo virus DNA sequences (prepared as described in the aforementioned reference) were also used as the detector for the DNA taggant. The complementary detector DNA had a length of 437 base pairs and was labelled using Biotin-16-dUTP at a DNA to label mole ratio of 1:1 during the PCR amplification. DNA concentration was measured by its absorbence at 260 nm.

Preparing DNA Tagged Beads.

DNA was dispensed onto the surface of the acrylated beads of the invention by a suitable method (such as soaking the beads in the DNA buffer). The DNA tagged beads (i.e. beads having strands of DNA attached to the surface) was incubated for one hour at 23° C. and subsequently washed once with a 0.2% (by weight) aqueous solution of sodium dodecyl sulphate (also referred to herein as SDS, available commercially from Merck) and then twice with water. The DNA tagged beads were then incubated for a further three minutes in boiling water to ensure that the single strands of nucleotide sequences were strongly attached the surface.

Hybridisation

A hybridisation solution was prepared comprising the detector DNA (prepared as described above) at a concentration of 10 nM in a solution of 0.35M phosphate buffer at pH7 with 4% SDS (such a buffer solution available commercially from AAT, Belgium). The hybridisation solution was brought into contact with the DNA tagged beads which were then heated to 50° C. for 2 hours. Afterwards the beads was washed four times with washing solution (10 mM maleate buffer at pH 7.5 with 0.1% Tween) and then incubated for 45 minutes with a streptavidin-gold conjugate (available commercially from Sigma, MO, USA). Then the beads was washed a further five times with the same washing solution and finally incubated for 10 minutes in another incubating solution (that available commercially from AAT, Belgium under the trade name Silver Blue Solution).

Results

Evaluation of the beads of the invention prepared as described herein was carried out according to well known standard methods and protocols and as described below

The tests may be performed successfully at different concentrations of NH₂-DNA probes: such as 25 nM, 50 nM and 200 nM.

The Functionalised beads of the invention made from Examples 5 to 8 herein were tested to demonstrate the impact of acrylate concentration on grafting capability. These results clearly indicate that the effect of increasing free acrylate concentration is to cause a corresponding increase in the grafting efficiency of the substrate.

The DNA tagged beads were isolated after exposure to the complementary detector DNA that had a biotin label. A positive response for standard procedures to detect radio labels showed that detector had bound to the DNA tagged particle.

Thus an article incorporating the DNA tagged particles of the present invention may also be identified by the corresponding detector DNA to indicate present of the taggant.

Tagged Films

It has been demonstrated that single stranded DNA can be successfully bound onto silica antiblock particles, and subsequently verified by hybridisation of the second strand. It can also be shown that these DNA labelled silica particles (also referred to herein as “bio-tags”) can be incorporated into conventional polymeric films. An authentication protocol to enable the film to be verified was also established.

Taggant in the Film Coat

### Example 11

### PVdC Coated BOPP Film

PVdC coated OPP film (that available commercially from UCB under registered trademark Propafilm® RX) was made with (Example 9) and without (Comp A) the added DNA tagged silica (Biotag) made analogously to the method described in Example 4. Both films were hybridised with a probe that contained a ‘Texas Red’ fluorescent marker. When analysed under the microscope, the tagged coated film (Example 9) showed signs of some faint fluorescent particles compared to the untagged film (Comp A).

### Example 12

### PVdC Coated Cellulose Film

Samples of a PVdC coated cellulose film (that available commercially from UCB under the registered trademark Cellophane® RX) were made with the DNA tagged silica (Biotag)—made analogously to the method described in Example 4—as the anti-block additive (Example 10) and conventional silica (available under the trade designation Gasil AB72) as the anti-block additive (Comp B). Both films were hybridised with the probe and observed under the fluorescence microscope and the results are summarised below:

| Sample | Observations |
|---|---|
| Comp B - Standard Silica | No fluorescence |
| Ex 10 - Biotag | Small green fluorescent particles |

### Example 13

### Acrylic Coated BOPP Film

An acrylic coating formulation for an OPP film (that used to make the coated film previously commercially available from UCB under the registered trademark Rayoface® WI) was made with the silica in the standard coating formulation (Comp C) being replaced with biotaged silica (Example 13, the DNA was bound to modified silica available under the trade designation Gasil AB72; made analogously to the method described in Example 4). Separate BOPP film samples were coated conventionally (hand draw downs) with each formulation. When the biotaged film (Example 13) was hybridised and observed under the microscope lots of fluorescent particles could be clearly seen. The film coated with conventional acrylic formulation (Comp C) did not fluoresce.

The applicant has found that using the silica Biotags in an acrylic formulation has certain advantages such as:

The difference between fluorescence in the marked (Example 13) and unmarked (Comp C) films is most striking and thus the taggant can be easily detected (with the correct probe). Films coated with this type of acrylic top coat can be printed using a digital printing method.

The formulation can be applied using conventional methods such as an opacification press, where for example bio-tagged formulation highly loaded with the biotag could be printed down onto the film in a small patch (in a window for example) which would lead to a film that could be more easily verified. The position of the patch could be carefully located to ensure that it is not over-lacquered or overprinted, to ensure the biotag is not prevented from being accessible, and the verification procedure would give an incorrect result.

Taggant in the Outer Film Layer

### Example 14

### Tagged BOPP Film

One the potential products that the taggent of the invention could be used for is tobacco overwrap, therefore it was decided to trial the biotag in conventional biaxially oriented polypropylene BOPP film (that available commercially from UCB Films under the trade designation GLS20 denoted herein as Comp D)

A batch of 50 g of the silica biotag (made as described in Example 4) was prepared and added to a polymer concentrate used conventionally to prepare an outer coat polymer for a conventional BOPP film (Comp D). The Biotag was used as a direct replacement for the usual conventional silica antiblock in this film. The biotagged outer coat polymer concentrate was using during an otherwise conventional manufacture of the BOPP film to produce a tagged film (denoted as Example 12). All conditions during the trial were as per standard untagged BOPP film (Comp D) which used conventional silica as the anti-block agent.

### Example 15

Another batch of silica biotag (prepared as Example 4) was made up and added to a standard outer coat polymer at 2000 ppm as described in Example 14. As a control, conventional film with the same amount of anti-block silica (to the biotag) was prepared (Comp E).

Results

When the Example 14 & 15 were compared to their controls (Comp D & E) it was confirmed that adding biotag had no significant effect on the properties of the film as all results were within the standard specification for the conventional films.

To ensure that the biotags are detected it is preferred that they are not covered by polymer, or other additives in the film cover them. Otherwise it is possible the fluorescent probe will not be able to get to the silica antiblock and will be prevented from being able to hybridise to the DNA. Microscopy analysis revealed that although some of the silica antiblock was covered in Example 14 the majority of the silica was available on the surface, and not covered by polymer.

The outer coat polymer of the film of Examples 14 and Comp D is formulated with high levels of silicone, which is designed to migrate to the surface of the film to act as a slip additive. It is possible that the silicone could migrate to could cover the antiblock particles and also prevent the probe from hybridising onto the DNA. It is not possible to detect whether the silicone covers the silica particles using microscopy analysis. Therefore preferably to remove the silicone from the surface of the film, both Example 14 and Comp D are washed in diethyl ether before hybridisation.

To ensure that when the probe is able to hybridise onto the DNA it produces fluorescence strong enough to be seen under the fluorescence microscope. Hybridisation may be repeated with increase (e.g. double) the concentration of probe to increase the level of fluorescence until the level required to obtain a positive result is reached.

To provide a good authentication test it is preferred that there is a significant difference between the films that contained the biotag and the control, so the fluorescence intensity is sufficient to provide a definitive test.

Thermal Stability Tests

In order to evaluate stability with respect to heat degradation, a sample of silica bound DNA was heated to 200° C. for 15 minutes. The heat-treated biotag was then tested (along with control samples) to see if the DNA could still be detected using the fluorescent probe. The sample of silica with no DNA bound to it showed no sign of any fluorescence when hybridised with the fluorescent probe, whereas both the heat treated, and the untreated biotags both fluoresced bright red. This is a clear indication that the film processing conditions do not cause any problems with regard to thermal degradation of the DNA during the manufacturing process.

The DNA thermal stability was investigated further. DNA that had been previously bound to modified silica was placed in the oven for the specified time and temperature. After heat treatment, each of the samples were hybridised with the fluorescent probe, and observed under the microscope.

Results

| Sample | Conditions | Hybridisation Result |
|---|---|---|
| 16 | No heat Treatment | Fluorescent |
| 17 | 60° C. for 16 hours | Fluorescent |
| 18 | 120° C. for 16 hours | Fluorescent |
| 19 | 200° C. for 15 mins. | Fluorescent |
| 20 | Control - no DNA | Not Fluorescent |

The results indicates that the DNA is thermally stable under quite severe conditions and at high temperatures. These experiments also indicate that the DNA is still easily detectable after prolonged aging at 120° C.

1. A process for tagging a particle for use in labelling an article for security, identification and/or authentication purposes comprising the steps of:
(a) optionally modifying (preferably functionalising) one or both of a taggant species and a surface of the particles so they are capable of reacting with each other to form a bond;
(b) reacting said taggant with said particle surface to bind the taggant thereto;
to form tagged particles.

2. A process as claimed in claim 1, in which the reaction in step (b) is an addition reaction between an activated unsaturated moiety and a polar group.

3. A process as claimed in claim 2, in which the addition reaction is between an acrylate group and an hydroxy or amino group.

4. A process as claimed in claim 1, in which the modifying step (a) comprises:
(a)(i) reacting the particles with an optionally substituted aminoalkyltrialkoxy silane;
(a)(ii) partially reacting the particles modified in step (a)(i) with an optionally substituted reagent comprising at least two acid or acid derived functional groups which are also capable of reacting directly with a terminal group on an informational molecule.

5. A process as claimed in claim 4, in which
in step (a)(i) the aminoalkyltrialkoxy silane comprises aminopropyltriethoxy silane; and
in step (a)(ii) the reagent is selected from:
a moiety comprising a polyethylene glycol spacer group, optionally polyethylene glycol dicarboxymethyl; optionally substituted succinic anhydride; and/or a diisothiocyanate (optionally 1,4-phenylene diisothiocyanate (PDITC)); and
where after step (a)(ii) the functional particle is capable of reacting directly with a terminal amide and/or hydroxy group of an oligonucleotide.

6. A process as claimed in claim 4, in which the particle comprise silica.

7. A process as claimed in claim 1, in which the taggant is an informational molecule comprising a sequence of at least eight elements.

8. A process as claimed in claim 7, in which the taggant is an oligonucleotide.

9. A process as claimed in claim 8, in which the oligonucleotide is a DNA single strand comprising a sequence of at least 25 bases.

10. A process as claimed in claim 1 in which the taggant comprises a polar group optionally added to the taggant in the functionalising step (a).

11. A process as claimed in claim 10, in which the informational molecule comprises a terminal hydroxy and/or amino group and is selected from a DNA strand comprising a sequence of at least eight base pairs and/or a peptide chain comprising a sequence of at least eight amino acids.

12. A process as claimed in claim 1 in which the surface of the particles to be tagged comprise an activated unsaturated moiety optionally added thereto in the functionalising step (a).

13. A process as claimed in claim 1, in which the particles to be tagged comprise silica and/or silicate optionally functionalised with one or more acrylate groups.

14. Tagged particles obtained or obtainable by a process described in claim 1, optionally comprising informational molecules with only one sequence thereon.

15. An article and/or document comprising the tagged particles as claimed in claim 14 in detectable amounts.

16. An article and/or document as claimed in claim 15, selected from:
antique objects; audio and/or visual media; chemical products ; tobacco products; clothing articles; beverages; entertainment goods; foodstuffs; electrical and/or electronics goods; computer software, high technology machines and/or equipment; jewellery; leisure items; perfumes and/or cosmetics; products related to or for the treatment, diagnosis, therapy and/or propylaxis of humans and/or animals; military equipment; photographic industry goods; scientific instruments and spare parts therefor, machinery and spare parts for the transport industry, travel goods; security documents; official documents issued by governments and/or other official and/or commercial institutions; bank notes, bonds, currency notes, cheque; share certificates, stamps, tax receipts, official records, diplomas, identification documents; security tags, labels, tickets, security badges, credit cards, packaging, brands; trademarks; logos; sports articles; and/or articles and/or documents suitable for attachment to and/or associated with any of the aforementioned articles.

17. A article and/or document as claimed in claim 15, which is a self supporting sheet optionally made from a thermopolymer and/or a biopolymer.

18. A sheet as claimed in claim 17, which comprises a polyolefin film, cellulose film and/or polylactic acid film.

19. A sheet as claimed in claim 17, which comprises one or more layers and where detectable amounts of tagged particles are incorporated into one or more of the outer (surface-most) layers.

20. A sheet as claimed in claim 17 which is coated with a composition comprising a detectable amount of the tagged particles.

21. A method for labeling an article and/or document for a security, identification and/or authentication purpose comprising incorporating therein the tagged particles as claimed in claim 14 in detectable amounts.

22. A method for authenticating an article comprising the steps of exposing an article and/or document as claimed claim 15 to a non destructive detecting means to identify the taggant present therein and verify the authenticity of the article tested.

23. An authenticating method as described in claim 22, where the detecting means comprising a probe with part which can be detected by electromagnetic radiation (optional in the visible region) and a part comprising an informational molecule which hybridises with a corresponding complementary informational molecule known to be incorporated in the authentic article.

24. An authenticating method as described in claim 23, where the probe comprises a coloured and/or fluorescent region attached to a single strand DNA which hybridises with the complementary DNA molecule known to be incorporated in the authentic article.

25. Use of the tagged particles claimed in claim 14 to provide a means for non destructively authenticating an article.

26. Method of manufacture of an article for the purpose of providing a means for non destructively authenticating said article, which comprises including the tagged particles of claim 14 with said article.
